(19) United States
(12) Patent Application Publication
(10) Pub. No.: US 2008/0116148 A1
(43) Pub. Date: May 22, 2008

(54) Treatment of Metal Melts

(76) Inventor: John Henry Courtenay, West Midlands (GB)

Correspondence Address: GOSZ AND PARTNERS LLP, ONE STATE STREET, BOSTON, MA, 02109, US

(21) Appl. No.: 10/589,598

(22) PCT Filed: Feb. 17, 2005
(86) PCT No.: PCT/GB05/00557

§ 371 Date: Aug. 16, 2006

(30) Foreign Application Priority Data
Feb. 17, 2004 (GB) 0403466.6

(51) Int. Cl. B01D 37/02; B01D 29/62

(52) U.S. Cl. 210/752; 210/209

(57) ABSTRACT

A method of maintaining the life of a porous filter when refining a metal melt by controlling the formation of a filter cake thereon, the method comprising passing liquid metal through a porous filter and adding a filter cake formation agent to the metal; contacting the filter metal with a grain refining agent followed by mechanical mixing to promote intimate mixing of the metal and the grain refining agent to produce refined metal, whereby a filter cake is formed on the porous filter without significant change in the metallostatic head above the filter.

It is known to remove both solid and gaseous inclusions from metal melts before they are cast in order to improve the quality of the casting. Several techniques are available for this purpose and one involves passing the liquid metal through the pores of a porous filter and then adding a grain refining agent.

U.S. Pat. No. 4,872,908 discloses a means of improving filtration by predisposing a pre wetted additive on the surface of a ceramic foam filter with the objective of promoting the formation of a stable filter cake leading to improved filtration. This patent does not, however, take account of the role of grain refiners in destroying the development of filter cakes and characteristics of the filter aperture required in the promotion of filter cake formation.

US-A-2002/005667 describes a three chamber filter assembly allowing addition of grain refiner rod into an intermediate chamber between the two filter chambers, the first being a ceramic foam filter whilst the second consists of a small filter bed containing spheres of alumina. Whilst the arrangement disclosed theoretically permits re-use of the first ceramic foam filter, it does not address the issue of how the rate of build up of the filter cake is to be controlled. If the filter cake build up is not controlled, this can lead to premature blocking of the filter. Moreover, bed filters of the type forming the secondary filter bed, are known to be complicated and expensive to maintain and in addition may encounter operational difficulties arising from the release of agglomerated grain refiner particles.

The invention is concerned with this latter technique and especially seeks to improve filtration efficiency and to prolong the life of the filter by controlling the filtration characteristics of the filter cake that forms on the filter, such as filter cake accumulation.

In one aspect the invention provides a method of maintaining the life of a porous filter when refining a metal melt by controlling the formation of a filter cake thereon, the method comprising passing liquid metal through a porous filter and adding a filter cake formation agent to the metal; contacting the filtered metal with a grain refining agent followed by mechanical mixing to promote intimate mixing of the metal and the grain refining agent to produce refined metal, whereby a filter cake is formed on the porous filter without significant change in the metallostatic head above the filter.

The metal to be treated may typically be a light metal such as aluminium or its alloys or any other metal from which inclusions need to be reduced or removed before grain refinement.

The porous filter may conveniently comprise a ceramic plate or block which has been formed by impregnating a sponge such as a polyurethane sponge and then burning away the organic material to leave a foraminferous structure. The pore dimensions will preferably be within the range of about 300 to about 2500 micron, and more preferably about 400 to about 600 micron.

The agent to promote the formation of a suitable filter cake may conveniently consist of particles preferably coated with substances which are wetted by the liquid metal and/or contain a fluxing agent such as a fluoride. The agent can be provided in briquette form which breaks down into particles when in contact with the liquid metal. The particles are most preferably selected and introduced so that the cake becomes deposited in layers which are non-compressible as a result of which the cake is itself inherently porous and the pores of the ceramic filter remain sufficiently open that metal can flow through without significant change in metallostatic head. (Δh).

Preferably the ceramic porous filter is located in one chamber which is separated by a partition defining an under weir in liquid communication with a second chamber into which grain refining agent is introduced, which will preferably be in a wire form. Preferably the wire is fed into the second chamber countercurrent to the direction of flow of the metal to promote good mixing and dissolution, i.e. so that the grain refining agent becomes substantially uniformly distributed in the metal within a mixing chamber adjacent or spaced from the filtration chamber without any adverse reactions taking place.

The mixing is effected to disperse the grain refining agent within the liquid melt in such a way as to prevent agglomeration of particles of the grain refining agent and to encourage a uniform distribution of the agent through the liquid melt, and to separate out any non-metallic inclusions emanating from the grain refiner or any other source. We have surprisingly found that good metal mixing effected in this ‘mechanical’ manner (and without supplementary mixing means) is more effective than a secondary stage filter.

The invention extends to filter apparatus comprising two or three chambers, such as for example filter apparatus including communicating chambers, a first chamber having an inlet and the second chamber having an outlet, a porous filter, preferably a ceramic filter, being present in the first chamber, and a grain refining agent being present in the second chamber which can be arranged with a series of baffles or other means of controlling flow, e.g. a cyclone, to mix the grain refining agent whilst simultaneously and/or sequentially separating out any undesirable particles such as said non-metallic inclusions from the liquid metal. A cyclone component is one example of a part of the apparatus specifically designed to induce swirl flow in the flowing, filtered and grain refined liquid metal, while simultaneously separating out unwanted particulate matter.

In order that the invention may be illustrated, more easily appreciated and readily carried into effect by those skilled in the art, embodiments of it will now be described by way of non-limited example only with reference to the accompanying diagrammatic drawings in which:

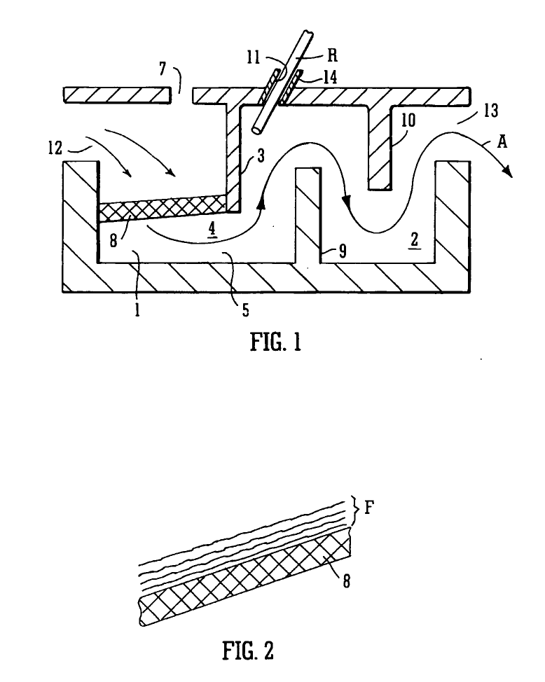

FIG. 1 shows a vertical section through one form of apparatus according to the invention; and

FIG. 2 shows an enlarged vertical section of a non-compressible filter cake, formed in use of apparatus depicted in FIG. 1.

Referring to the drawings and firstly to FIG. 1 thereof, the apparatus comprises a filter box comprising a first chamber 1 and a second chamber 2 separated by a partition 3 dimensioned to define an underweir 4 in collaboration with the floor 5. The chambers have a roof 6 with an inlet 7 for the introduction of an agent for forming the filter cake F, (FIG. 2). The first chamber 1 contains a porous ceramic filter plate or block 8. The inlet 7 in the roof 6 is vertically above the filter 8. The agent for forming the nature of the filter cake preferably provides relatively large particles which settle on the top of the filter (and on successive layers of material thereto) and tend to hold the layers apart, i.e. prevent being compressed. As a result, the filter cake tends to have a more open, i.e. porous structure, and there is less likelihood of the pores of the filter itself becoming blocked. As a result the life of the filter is prolonged and the nature of the filter cake is improved.

The second chamber 2 contains baffles 9 and 10, standing up from the floor 5 or depending from the roof 6, respectively. An inlet 11 in the roof 6 above the second chamber 2 has a guide tube 14 which receives a grain refining agent R in wire form. The inlet 11 is inclined to the vertical so that the wire enters the second chamber 2 in a direction countercurrent to the flow of the metal melt.

In use, the liquid metal flows under gravity from the inlet 12 of the first chamber 1 to an outlet 13 of the second chamber 2 in the direction shown by the arrow A. As the molten metal flows over the filter plate 8 the filter cake agent is caused to fall via the roof inlet 7 to join the flowing liquid metal. The particles settle on the plate 8 to form the filter cake F in layers which are uncompressed so that they do not form a solid impenetrable barrier. As a result the filter continues to function and there is little change in the metallostatic head above the filter 8. The filtered metal flows from the filter 8 via the underweir 4 into the second chamber 2, where the adjacent end of the wire R is melted to release the grain refining agent. The filtered metal entraining the grain refining agent is subjected to flow modification by being passed between the baffles 9 and 10 where there is good ‘mechanical’ mixing in the absence of further mixing means as a result of which the grain refining agent becomes well dispersed throughout the liquid metal. The metal leaves via the outlet 13 to be cast.

### EXAMPLE 1

An apparatus as described above in relation to FIG. 1 was constructed and operated using AA1050 aluminium alloy prepared from potline metal and wire form grain refiner of the type 5:1 titanium boron composition such that the ceramic filter was operated in ‘filter-cake’ mode in which the filtrate, i.e. the exit metal flow was significantly improved. A casting trial was carried out on an experimental casting unit with a casting rate of 8 tonnes/hr and a drop size of 11 tonnes. Measurements of inclusion content were made by using two LiMCA particulate counting devices, one placed before the apparatus and the other located after the apparatus. Table 1 below provides the LiMCA particulate evaluations for the casting trial demonstrating improvements of the order tenfold in terms of the outlet particle count compared to standard performance expected from a ceramic filter used according to current industry practise.

| | Exit |
|---|---|
| Incoming | |
| N15 12,000 | 500-1,000 counts |
| N20 8,000 | 200-500 counts |
| STANDARD | |
| N20 10,000 | 5,000 |

### EXAMPLE 2

The apparatus and procedure of Example 1 was repeated several times each using different alloy compositions. By corresponding control of filter cake accumulation, it was found that the ceramic filter was re-usable for a minimum of three times for the different alloy types including AA1000 series, AA3000 series and AA 5000 series alloys whilst maintaining the same high levels of filtration efficiency.

The porous filter is long lasting because the nature of the filter cake allows its continued use over a prolonged period. Our investigations have shown that by control of the nature of the filter cake the reliability and efficiency of the filter is improved with filter life being increased at least threefold whilst achieving and sustaining remarkably high levels of filtration efficiency in excess of 90% for a wide range of different types of alloy. The metal produced is well refined, containing a very low level of particulates (in the range of 200 to 500 counts/kg) and importantly containing no particulates greater than 40 micron in size, particles greater than this size having been substantially removed by modification of the metal flow.

1-20. (canceled)

21. A method of maintaining the life of a porous filter when refining a metal melt by controlling the formation of a filter cake thereon, the method comprising passing liquid metal through a porous filter and adding a filter cake formation agent to the metal; contacting the filtered metal with a grain refining agent followed by mechanical mixing to promote intimate mixing of the metal and the grain refining agent to produce refined metal, whereby a filter cake is formed on the porous filter without significant change in the metallostatic head above the filter.

22. A method as claimed in claim 1, wherein the metal to be refined is a light metal such as aluminium or an alloy comprising aluminium.

23. A method as claimed in claim 1, in which the porous filter comprises a ceramic block or plate.

24. A method as claimed in claim 1, in which the pore dimensions of the porous filter are in the range of about 300 to about 2,500 micron.

25. A method as claimed in claim 1, in which the filter cake formation agent consists of particles coated with substances wetted by the liquid metal and/or containing a fluxing agent such as a fluoride.

26. A method as claimed in claim 1, in which the filter cake becomes formed in layers which are non-compressible.

27. A method as claimed in claim 1, in which the porous filter is located in one chamber separated from another chamber into which the grain refining agent is introduced.

28. A method as claimed in claim 7, in which the said chambers are adjacent.

29. A method as claimed in claim 7, in which the grain refining agent is fed into the said another chamber countercurrent to the direction of flow of the liquid metal.

30. A method as claimed in claim 1, wherein particulates greater than 40 micron in size are substantially removed from the grain refined metal.

31. A method of maintaining the life of a porous filter when refining a metal melt by controlling the formation of a filter cake thereon, the method comprising passing liquid metal through a porous filter and adding a filter cake formation agent to the metal; contacting the filtered metal with a grain refining agent followed by flow modification to promote intimate mixing of the metal and the grain refining agent to produce refined metal, whereby a filter cake is formed on the porous filter without significant change in the metallostatic head above the filter.

32. A method as claimed in claim 11, wherein the metal to be refined is a light metal such as aluminium or an alloy comprising aluminium.

33. A method as claimed in claim 11, in which the porous filter comprises a ceramic block or plate.

34. A method as claimed in claim 11, in which the pore dimensions of the porous filter are in the range of about 300 to about 2,500 micron.

35. A method as claimed in claim 11, in which the filter cake formation agent consists of particles coated with substances wetted by the liquid metal and/or containing a fluxing agent such as a fluoride.

36. A method as claimed in claim 11, in which the filter cake becomes formed in layers which are non-compressible.

37. A method as claimed in claim 11, in which the porous filter is located in one chamber separated from another chamber into which the grain refining agent is introduced.

38. A method as claimed in claim 17, in which the said chambers are adjacent.

39. A method as claimed in claim 17, in which the grain refining agent is fed into the said another chamber countercurrent to the direction of flow of the liquid metal.

40. A method as claimed in claim 11, wherein particulates greater than 40 micron in size are substantially removed from the grain refined metal.

41. A method of refining a metal melt comprising passing liquid metal through a porous filter whilst adding filter cake forming agent to a flow of liquid metal, subjecting the filtered metal to grain refinement by addition of grain refining agent with simultaneous admixing of liquid metal with said grain refining agent followed by separation of at least some particulate matter from the flow of liquid metal characterised in that the liquid metal flow is subjected to only one filtration stage.

42. A method as claimed in claim 21, in which the admixing of liquid metal and/or separation of particulate matter is effected through liquid metal flow modification.

43. A method as claimed in claim 21, wherein the metal to be refined is a light metal such as aluminium or an alloy comprising aluminium.

44. A method as claimed in claim 21, in which the porous filter comprises a ceramic block or plate.

45. A method as claimed in claim 21, in which the pore dimensions of the porous filter are in the range of about 300 to about 2,500 micron.

46. A method as claimed in claim 21, in which the filter cake formation agent consists of particles coated with substances wetted by the liquid metal and/or containing a fluxing agent such as a fluoride.

47. A method as claimed in claim 21, in which the filter cake becomes formed in layers which are non-compressible.

48. A method as claimed in claim 21, in which the porous filter is located in one chamber separated from another chamber into which the grain refining agent is introduced.

49. A method as claimed in claim 28, in which the said chambers are adjacent.

50. A method as claimed in claim 28, in which the grain refining agent is fed into the said another chamber countercurrent to the direction of flow of the liquid metal.

51. A method as claimed in claim 21, in which separation of said particulate matter is achieved by the presence of baffle plates modifying the path of flow of the liquid metal.

52. A method as claimed in claim 21, in which separation of said particulate matter is achieved in means generating swirl flow in the liquid metal, such as within a cyclone.

53. A method as claimed in claim 21, wherein particulates greater than 40 micron in size are substantially removed from the grain refined metal.

54. Apparatus constructed and arranged to carry into effect a method as claimed in claim 1, comprising a primary compartment to receive an inlet flow of liquid metal and including filtration means in the form of a porous filter adapted to support, in use, a build-up of filter cake, means for introducing into the said primary compartment filter cake controlling agent and a secondary compartment adjacent to or spaced from the primary compartment to receive a flow of filtered liquid metal and including an inlet for grain refining agent, the apparatus being constructed or incorporating means to cause admixing of the flowing filtered liquid metal with introduced grain refining agent, and further constructed to or incorporating means to separate at least some particulate matter from the filtered and grain refined liquid metal flow after admixture with the grain refining agent, the apparatus being characterised by a single filtration means.

55. Apparatus as claimed in claim 34, in which the porous filter is located at and defines the base of the metal feed inlet compartment within the primary chamber.

56. Apparatus as claimed in claim 34, in which the grain refining agent inlet is angled at an acute angle with respect to the secondary compartment to cause intimate admixture of the grain refining agent with flowing filtered liquid metal.

57. Apparatus as claimed in claim 34, including a plurality of baffle plates situated to effect modification to the flow of liquid metal towards an exit of the apparatus.

58. Apparatus as claimed in claim 34, including a means for generating swirl flow to induce separation of at least some particulate matter, in use, from flowing filtered and grain refined liquid metal.

59. Apparatus constructed and arranged to carry into effect a method as claimed in claim 11, comprising a primary compartment to receive an inlet flow of liquid metal and including filtration means in the form of a porous filter adapted to support, in use, a build-up of filter cake, means for introducing into the said primary compartment filter cake controlling agent and a secondary compartment adjacent to or spaced from the primary compartment to receive a flow of filtered liquid metal and including an inlet for grain refining agent, the apparatus being constructed or incorporating means to cause admixing of the flowing filtered liquid metal with introduced grain refining agent, and further constructed to or incorporating means to separate at least some particulate matter from the filtered and grain refined liquid metal flow after admixture with the grain refining agent, the apparatus being characterised by a single filtration means.

60. Apparatus as claimed in claim 39, in which the porous filter is located at and defines the base of the metal feed inlet compartment within the primary chamber.

61. Apparatus as claimed in claim 39, in which the grain refining agent inlet is angled at an acute angle with respect to the secondary compartment to cause intimate admixture of the grain refining agent with flowing filtered liquid metal.

62. Apparatus as claimed in claim 39, including a plurality of baffle plates situated to effect modification to the flow of liquid metal towards an exit of the apparatus.

63. Apparatus as claimed in claim 39, including a means for generating swirl flow to induce separation of at least some particulate matter, in use, from flowing filtered and grain refined liquid metal.

64. Apparatus constructed and arranged to carry into effect a method as claimed in claim 21, comprising a primary compartment to receive an inlet flow of liquid metal and including filtration means in the form of a porous filter adapted to support, in use, a build-up of filter cake, means for introducing into the said primary compartment filter cake controlling agent and a secondary compartment adjacent to or spaced from the primary compartment to receive a flow of filtered liquid metal and including an inlet for grain refining agent, the apparatus being constructed or incorporating means to cause admixing of the flowing filtered liquid metal with introduced grain refining agent, and further constructed to or incorporating means to separate at least some particulate matter from the filtered and grain refined liquid metal flow after admixture with the grain refining agent, the apparatus being characterised by a single filtration means.

65. Apparatus as claimed in claim 44, in which the porous filter is located at and defines the base of the metal feed inlet compartment within the primary chamber.

66. Apparatus as claimed in claim 44, in which the grain refining agent inlet is angled at an acute angle with respect to the secondary compartment to cause intimate admixture of the grain refining agent with flowing filtered liquid metal.

67. Apparatus as claimed in claim 44, including a plurality of baffle plates situated to effect modification to the flow of liquid metal towards an exit of the apparatus.

68. Apparatus as claimed in claim 44, including a means for generating swirl flow to induce separation of at least some particulate matter, in use, from flowing filtered and grain refined liquid metal.
